(19) United States
(12) Patent Application Publication
(10) Pub. No.: US 2025/0010518 A1
(43) Pub. Date: Jan. 9, 2025

(54) UNLOADING AND COLLECTING DEVICE FOR SLICE AND CUTTING MACHINE WITH THE SAME

(71) Applicant: TCL ZHONGHUAN RENEWABLE ENERGY TECHNOLOGY CO., LTD., Tianjin (CN)

(72) Inventors: Xuelong LIN, Tianjin (CN); Yujun XING, Tianjin (CN); Zhijian LI, Tianjin (CN); Dalai TONGLAGA, Tianjin (CN); Gang LI, Tianjin (CN); Huihui WANG, Tianjin (CN); Ruiqing TIAN, Tianjin (CN); Chaohui DONG, Tianjin (CN); Junlei GUO, Tianjin (CN); Xin ZHAO, Tianjin (CN); Wen WANG, Tianjin (CN)

(73) Assignee: TCL ZHONGHUAN RENEWABLE ENERGY TECHNOLOGY CO., LTD., Tianjin (CN)

(21) Appl. No.: 18/548,075

(22) PCT Filed: Jul. 31, 2023
(86) PCT No.: PCT/CN2023/110419

§ 371 Date: Aug. 26, 2023

(30) Foreign Application Priority Data
Sep. 2, 2022 (CN) 202222327234.X

(51) Int. Cl. B28D 5/00

(52) U.S. Cl. CPC B28D 5/0094; B28D 5/0064

(57) ABSTRACT

An unloading and collecting device for slice and a cutting machine with the same are provided. The device is configured to collect the slice cut from an end of a silicon rod. The device includes a tray, a box, and a movable assembly, and the movable assembly has a rod member connected to the tray. The rod member drives the tray to adsorb the slice, and the movable assembly is operatable to move the tray in a first direction and a second direction, and to rotate the tray to the box.

### CROSS-REFERENCE TO RELATED DISCLOSURE

The present disclosure claims priority to Chinese Patent Application No. 202222327234.X, filed Sep. 2, 2022, titled “UNLOADING AND COLLECTING DEVICE FOR SLICE AND CUTTING MACHINE WITH THE SAME”, which is incorporated herein by reference in its entirety.

### TECHNICAL FIELD

The present disclosure relates to a technical field of detecting a single crystal silicon rod, and particularly relates to an unloading and collecting device for slice and a cutting machine with the same.

### BACKGROUND

During preparing a solar silicon rod, content of oxygen and carbon content at ends of a silicon rod is detected to determine whether parameters of the content of oxygen and carbon of the silicon rod in overall meet a standard. In general, the silicon rod is placed on a cutting machine to be cut with the slice at the ends of the crystal silicon rod by means of rigid wire cutting. The slice cut falls into a collection box by the gravity of the slice, thereby unloading the slice. However, due to collecting by gravity, there is a risk of breaking the slice into pieces. A great potential safety hazard is here. In addition, there is a waste of work time in waiting the slice to fall down by gravity, which affects production efficiency and is disadvantageous to automatic production.

### SUMMARY

An unloading and collecting device for slice and a cutting machine with the same are provided, which alleviates a risk of breaking the slice into pieces during collecting by gravity, and a risk of causing low production efficiency.

The unloading and collecting device for slice and the cutting machine with the same are described at least by embodiments.

An unloading and collecting device for slice, configured to collect the slice cut from an end of a silicon rod, wherein the device includes a tray, a box, and a movable assembly, and the movable assembly has a rod member connected to the tray, wherein the rod member drives the tray to adsorb the slice, and the movable assembly is operatable to move the tray in a first direction and a second direction, and to rotate the tray to the box.

In an embodiment, a plurality of vacuum suction holes and a detector are provided on the tray, the plurality of vacuum suction holes are disposed along a radial periphery of the tray, and the detector is configured to detect a position of the slice.

In an embodiment, the movable assembly further includes a cantilever arm, and a driving member hinged to the cantilever arm; wherein an axis of the cantilever arm is perpendicular to the first direction; wherein the driving member is connected with the rod member; wherein the driving member drives the rod member to move the tray close to and away from the slice in the first direction, and drives the rod member together with the tray to rotate around the cantilever arm.

In an embodiment, the rod member is disposed on a side surface of the driving member and is coaxial with the driving member; wherein ends of the rod member are respectively connected with the tray and the driving member in the first direction.

In an embodiment, the rod member is configured as a cylinder push rod.

In an embodiment, the device further includes a beam frame, wherein a rail and a slider are provided on the beam frame, the slider is cooperated with the rail, the cantilever arm is connected to the slider, and the rail is arranged in the first direction.

In an embodiment, the device further includes a telescopic shaft disposed between the slider and the cantilever arm, wherein the telescopic shaft is configured to extend close to the box and retract away from the box in the second direction.

In an embodiment, the box is disposed on a side of the movable member away from the silicon rod and below the movable assembly.

In an embodiment, the box has an opening upward, and an elastic pad is arranged at least on a bottom of the box.

A cutting machine including the above described unloading and collecting device according to any one of the embodiments is provided.

The unloading and collecting device for slice and the cutting machine with the same are provided in the disclosure. The device is adaptable to collect the slice cut from the silicon rod with different lengths. The slice can be quickly and accurately separated from the end of the silicon rod by providing the device, and a qualitied collection of the slice after unloading is further provided. According to the device of the present disclosure, the slice is adsorbed by the vacuum suction hole and is driven to move to the box at a fixed position. The whole process is automatically controlled. Not only the slice can be quickly adsorbed to save the work time, but also the quality of the slice can be ensured. A risk of a damage caused by bumps to the slice is avoided.

### BRIEF DESCRIPTION OF THE DRAWINGS

In order to make the embodiments of the present disclosure or the technical solutions in the prior art more clearly, reference will now be made to the accompanying drawings used in the description of the embodiments or the prior art, and it will be apparent that the accompanying drawings in the description below are merely some of the embodiments of the present disclosure, and other drawings may be made to those skilled in the art without any inventive effort.

FIG. 1 is a schematic structural diagram of an unloading and collecting device for slice according to an embodiment of the present disclosure.

FIG. 2 is a front view of a movable assembly according to an embodiment of the present disclosure.

FIG. 3 is a side view of a movable assembly according to an embodiment of the present disclosure.

FIG. 4 is a rear view of a movable assembly according to an embodiment of the present disclosure.

FIG. 5 is a schematic structural diagram of a slot box according to an embodiment of the present disclosure.

LIST OF REFERENCE SIGNS

| | | |
|---|---|---|
| 10: Tray; | 20: Box; | 30: Movable assembly; |
| 31: Rod member; | 32: Cantilever arm; | 33: Driving member; |
| 34: Beam frame; | 35: Rail; | 36: Telescopic shaft; |
| 37: Slider; | 40: Silicon rod; | 50: Slice. |

### DETAILED DESCRIPTION OF THE EMBODIMENTS

In order that the above objects, features and advantages of the present disclosure may be more readily understood, reference will now be made in detail to the accompanying drawings. In the following description, numerous specific details are set forth in order to facilitate a thorough understanding of the present disclosure. However, the present disclosure can be practiced in many other ways than those described herein, and those skilled in the art can make similar modifications without departing from the spirit of the present disclosure, and thus the present disclosure is not limited to the specific embodiments disclosed below.

In the description of this disclosure, it should be understood that the azimuth or positional relationship indicated by the terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential”, and the like, is based on the azimuth or positional relationship shown in the accompanying drawings, merely for ease of description of this disclosure and simplification of the description, and is not intended to indicate or imply that the indicated device or element must have a particular azimuth, be constructed and operated in a particular azimuth, and therefore is not to be construed as limiting of this disclosure.

Furthermore, the terms “first” and “second” are used for descriptive purposes only and are not to be construed as indicating or implying relative importance or implying the number of indicated technical features. Thus, the features with “first” and “second” indicate or imply to have at least one of these features. In the description herein, “a plurality of” means at least two, e.g., two, three, etc., unless expressly and specifically defined otherwise.

In the present disclosure, unless expressly defined and defined otherwise, terms such as “mounted”, “linked”, “connected”, “fixed”, and the like, should be understood as a border meaning, for example, may be fixedly connection, detachably connection, or a integrally connection; may be a mechanical connection or an electrical connection; may be a directly connection or an indirectly connection by means of an intermediate medium; and may be an internal communication of the two elements or interaction of the two elements, unless expressly defined otherwise. The specific meaning of the above terms in this disclosure may be understood by one of ordinary skill in the art depending on the specific circumstances.

In the present disclosure, unless expressly stated and defined otherwise, the first feature may be “on” or “under” the second feature may mean that the first feature directly contacts with the second feature or indirectly contacts with the second feature through an intermediate medium. And the first feature may be “over”, “above” or “up” the second feature may mean that the first feature may be directly above or obliquely above the second feature, or merely indicate that the first feature is higher than the second feature. The first feature may be “beneath”, “below” or “down” the second feature may mean that the first feature may be directly above or obliquely under the second feature, or merely indicate that the first feature is shorter than the second feature.

It should be noted that when an element is referred to as being “fixed to” or “disposed in” another element, it means that the element may be directly on another element or an intermediate element may be disposed therebetween. When an element is considered to “be connected to” another element, it means that the element may be directly connected to another element or an intermediate element may be connected therebetween. As used herein, the terms “vertical”, “horizontal”, “up”, “down”, “left”, “right”, and the like are used for purposes of illustration only and are not intended to be the only embodiments.

The present disclosure should be described in detail with reference to the accompanying drawings and embodiments.

Since lengths of different silicon rods are not equal, the different silicon rods are cut at different positions at the ends. As a result, positions where conventional boxes for collecting the slices are placed are not determined. Thus, it is inconvenience for unloading and collecting the slices. With a conventional unloading and collecting device, the slice falls down by the gravity. However, the slice is attached to an end of the silicon rod due to an adsorbing force of a cutting fluid sprayed during cutting the slice from the silicon rod. As such, the slice is not easily dropped, and it takes a long time for the slice to fall into the box. Although the slice falls instantaneously after being separated from the silicon rod against the adsorbing force, the slice is accelerated by the gravity. The slice falls into the box at a relatively high speed and easily collides with an inner cavity of the box, thereby causing the slice broken or cracked. Therefore, it is desired to design an unloading and collecting device adaptable for collecting the slice cut from the silicon rod with different lengths, for separating the slice from the end of the silicon rod quickly and accurately, and for ensuring the quality of the slice during unloading.

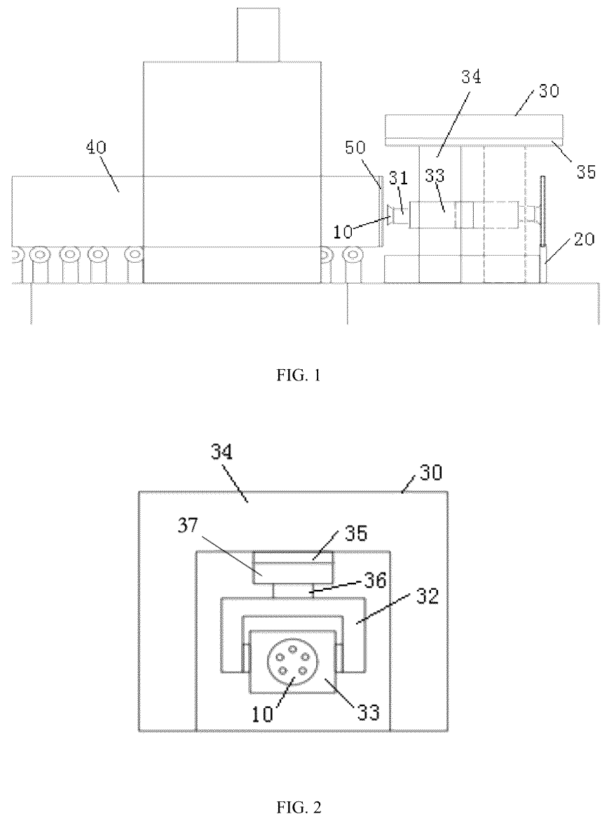

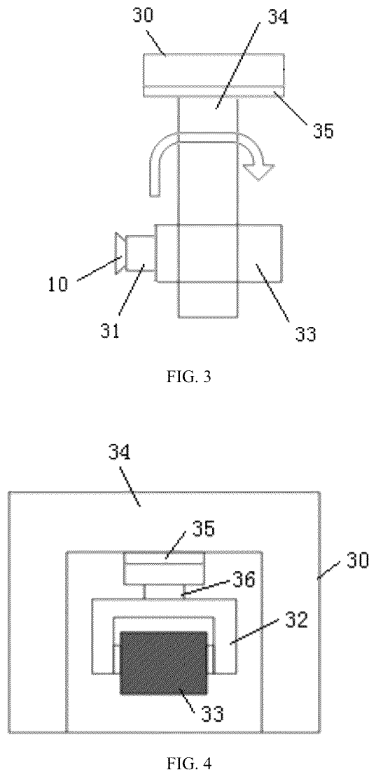

An unloading and collecting device for slice is provided according to the present disclosure. As shown in FIGS. 1 to 4, the device is configured to collect a slice 50 cut from an end of the silicon rod 40, wherein the device includes a tray 10, a box 20 and a movable assembly 30. The movable assembly 30 at least includes a rod member 31 connected to the tray 10. The rod member 31 drives the tray 10 to adsorb the slice 50. The movable assembly 30 can move the tray 10 in a first direction and in a second direction. The movable assembly 30 can rotate the tray 10 to the box 20.

In an embodiment, the silicon rod 40 is placed on a sliding table of a cutting machine. The first direction refers to a horizontal direction in which the silicon rod 40 is placed, and the first direction is perpendicular to a plane in which the slice 50 is placed. The second direction refers to a vertical direction perpendicular to the horizontal direction.

In an embodiment, the tray 10 is provided with a plurality of vacuum suction holes and a detector (not shown), wherein the plurality of vacuum suction holes are provided along a radial periphery of the tray 10, and the detector is configured to detect a position of the slice 50. Here, the tray 10 has a circular shape, and in an embodiment, an outer diameter of the tray 10 corresponds to an outer diameter of the slice 50. An area of the tray 10 is not provided too large, otherwise the tray 10 may interfere with the box 20 during unloading, and the slice 50 may not be collected into the box 20. The area of the tray 10 is not provided too small, otherwise the tray 10 may not adsorb the slice 50 to separate the slice 50 from the end of the silicon rod 40. The tray 10 communicates with an external vacuum pump through the vacuum suction hole, and when the slice 50 is desired to be adsorbed, the slice 50 may be separated from the silicon rod 40 by contacting the end surface of the slice 50 with the vacuum suction hole. When it is desired to adsorb the slice 50, the vacuum section hole contacts with the slice 50 to separate the slice 50 from the silicon rod 40. When it is desired to unload the slice 50, the adsorbing force between the vacuum suction hole and the slice 50 is controlled to gradually separate the slice 50 from the tray 10 and to fall the slice 50 into the box 20. The detector is a position sensor is configured to detect and position the slice 50.

Further, the movable assembly 30 further includes a cantilever arm 32 and a driving member 33 hinged to the cantilever arm 32. An axis around which the driving member 33 is hinged and rotated with the cantilever arm 32 is perpendicular to the first direction, that is, perpendicular to a length side of the silicon rod 40. The cantilever arm 32 is disposed across a diameter side of the silicon rod 40. The driving member 33 is a variable speed motor, and an output end of the driving member 33 is connected to the rod member 31, wherein the rod member 31 is configured as a cylinder push rod. The rod member 31 is disposed on a side surface of the driving member 33 and is coaxial with the driving member 33, that is, a length side of the rod member 31 is perpendicular to the axis around which the driving member 33 is hinged and rotated with the cantilever arm 32. The rod member 31 is connected to the tray 10 and the driving member 33 in the first direction, respectively. At the same time, ends of the driving member 33 are hinged with the cantilever arm 32 through rotating shafts in the second direction, and the driving member 33 is rotated in the second direction.

The driving member 33 may drive the rod member 31 to telescope in the first direction so as to move the tray 10 close to and away from the slice 50, and the driving member 33 may drive the tray 10 with the rod member 31 to rotate around the cantilever arm 32. That is, the driving member 33 may drive the rod member 31 along the first direction (the length side of the silicon rod 40) toward the slice 50 to adsorb the slice 50 and separate the slice 50 from the silicon rod 40. The rod member 31 then is further controlled to retract, and the driving member 33 drives the tray 10 adsorbing the slice 50 to rotate 180 degrees around the cantilever arm 32. That is, the driving member 33 rotates 180 degrees to change the position of the slice 50 adsorbed by the tray 10. Moreover, the slice 50 does not interference with other parts during rotating 180 degrees. In an embodiment, the tray 10 is needed to be disposed coaxially with the silicon rod 40 during adsorbing the slice 50, as such, the driving member 33 and the rod member 31 are relatively closer to the sliding table of the cutting machine. To avoid bumps to the slice 50 during rotating the slice 50, in an embodiment, the driving member 33 rotates the tray 10 and the slice 50 with 180 degrees in clockwise. And the slice 50 is directly rotated to a side where the box 20 is placed, and the slice 50 is disposed vertically. After unloading the slice 50, the tray 10 is then driven to rotate back 180 degrees in counterclockwise to its initial position.

Further, the movable assembly 30 further includes a beam frame 34, and the beam frame 34 is a gantry frame and is arranged across the width side of the sliding table of the cutting machine. The beam frame 34 is provided with a rail 35 and a slider 37 matched with the rail 35, and the cantilever arm 32 is connected to the rail 35 through the slider 37. The rail 35 is arranged in the first direction, that is, the rail 35 is horizontally arranged in the length side of the silicon rod 40 to move the cantilever arm 32 front and rear in the first direction. The slice 50 is driven to move in a case that a horizontal distance between the box 20 and the silicon rod 40 is large.

Further, a telescopic shaft 36 is provided between the slider 37 and the cantilever arm 32 to move close to and away from the box 20 in the second direction. The tray 10 is controlled by the telescopic shaft 36 to move vertically up and down, to avoid the tray 10 from being too close to the sliding table of the cutting machine, and to prevent the tray 10 from the bumps during moving in the horizontal direction, that is, in the first direction.

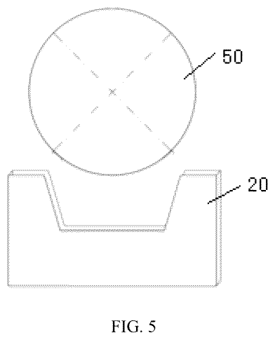

As shown in FIGS. 1 and 5, the box 20 is disposed on a side of the movable member 30 away from the silicon rod 40 and below the movable member 30. The box 20 is provided with at least one slot for receiving the slice 50. The box 20 has an opening upward, that is, the box 20 is an upright structure. A width side of the box 20 is flush with the plane of the slice 50. The structure of the box 20 may be based on actual needs, and is not specifically limited herein. An elastic pad is provided at the bottom of the box 20, and the elastic pad is made of sponge to provide a buffer to the slice 50 when the slice 50 is unloaded. In an embodiment, the elastic pad is provided on the bottom and peripheral wall of the inner cavity of the box 20 to prevent the slice from slipping off.

During operating, the cantilever arm 32 is controlled to move the driving member 33, the rod 31 and the tray 10 together along the rail 35 through the telescopic shaft 36 toward a side close to the silicon rod 40. The movement is stopped until the tray 10 is close to the silicon rod 40 and a gap is provided between the tray 10 and the silicon rod 40. The telescopic shaft 36 is further controlled to extend vertically and downward until the slice 50 is detected by the detector on the tray 10, and at the same time, the tray 10 is arranged concentrically with the slice 50. The rod member 31 is further controlled to move horizontally toward the end of the silicon rod 40 in the first direction until the tray 10 is in contact with the slice 50. The slice 50 is adsorbed by the suction vacuum hole on the tray 10 through vacuumizing. The rod member 31 is controlled to retract to separate the slice 50 from the end of the silicon rod 40. The driving rod 33 is driven to rotate the tray 10 and the slice 50 by 180 degrees in clockwise. Further the cantilever arm 32 is controlled to move along the rail 35 toward a side away from the silicon rod 40 to the box 20. Further the adsorbing force between the tray 10 and the slice 50 (the adsorbing force is provided between the vacuum section holes and the slice 50 by vacuuming) is controlled to separate the slice 50 from the tray 10, and the slice 50 falls into the box 20. Then, the driving member 33 is controlled to rotate the tray 10 and the slice 50 by 180 degrees in counterclockwise, and to move along the rail 35 to the side close to the silicon rod 40 to prepare a next unloading of the slice 50.

A cutting machine including the above described unloading and collecting device is provided.

The unloading and collecting device for slice and the cutting machine with the same are provided in the disclosure. The device is adaptable to collect the slice cut from the silicon rod with different lengths. The slice can be quickly and accurately separated from the end of the silicon rod by providing the device, and a qualitied collection of the slice after unloading is further provided. According to the device of the present disclosure, the slice is adsorbed by the vacuum suction hole and is driven to move to the box at a fixed position. The whole process is automatically controlled. Not only the slice can be quickly adsorbed to save the work time, but also the quality of the slice can be ensured. A risk of a damage caused by bumps to the slice is avoided.

The embodiments of the present disclosure have been described in detail above, but the description is only a preferred embodiment of the present disclosure and should not be considered as limiting the scope of implementation of the present disclosure. All equivalents and modifications made in accordance with the scope of the present disclosure is within the scope of the patent of the present disclosure.

What is claimed is:

1. An unloading and collecting device for slice, configured to collect the slice cut from an end of a silicon rod, wherein the device comprises a tray, a box, and a movable assembly, and the movable assembly has a rod member connected to the tray, wherein the rod member drives the tray to adsorb the slice, and the movable assembly is operatable to move the tray in a first direction and a second direction, and to rotate the tray to the box.

2. The unloading and collecting device for slice of claim 1, wherein a plurality of vacuum suction holes and a detector are provided on the tray, the plurality of vacuum suction holes are disposed along a radial periphery of the tray, and the detector is configured to detect a position of the slice.

3. The unloading and collecting device for slice of claim 1, wherein the movable assembly further comprises a cantilever arm, and a driving member hinged to the cantilever arm;
wherein an axis of the cantilever arm is perpendicular to the first direction;
wherein the driving member is connected with the rod member;
wherein the driving member drives the rod member to move the tray close to and away from the slice in the first direction, and drives the rod member together with the tray to rotate around the cantilever arm.

4. The unloading and collecting device for slice of claim 2, wherein the movable assembly further comprises a cantilever arm, and a driving member hinged to the cantilever arm;
wherein an axis of the cantilever arm is perpendicular to the first direction;
wherein the driving member is connected with the rod member;
wherein the driving member drives the rod member to move the tray close to and away from the slice in the first direction, and drives the rod member together with the tray to rotate around the cantilever arm.

5. The unloading and collecting device for slice of claim 3, wherein the rod member is disposed on a side surface of the driving member and is coaxial with the driving member;
wherein ends of the rod member are respectively connected with the tray and the driving member in the first direction.

6. The unloading and collecting device for slice of claim 5, wherein the rod member is configured as a cylinder push rod.

7. The unloading and collecting device for slice of claim 5, further comprising a beam frame, wherein a rail and a slider are provided on the beam frame, the slider is cooperated with the rail, the cantilever arm is connected to the slider, and the rail is arranged in the first direction.

8. The unloading and collecting device for slice of claim 6, further comprising a beam frame, wherein a rail and a slider are provided on the beam frame, the slider is cooperated with the rail, the cantilever arm is connected to the slider, and the rail is arranged in the first direction.

9. The unloading and collecting device for slice of claim 7, further comprising a telescopic shaft disposed between the slider and the cantilever arm, wherein the telescopic shaft is configured to extend close to the box and retract away from the box in the second direction.

10. The unloading and collecting device for slice of claim 1, wherein the box is disposed on a side of the movable member away from the silicon rod and below the movable assembly.

11. The unloading and collecting device for slice of claim 2, wherein the box is disposed on a side of the movable member away from the silicon rod and below the movable assembly.

12. The unloading and collecting device for slice of claim 5, wherein the box is disposed on a side of the movable member away from the silicon rod and below the movable assembly.

13. The unloading and collecting device for slice of claim 6, wherein the box is disposed on a side of the movable member away from the silicon rod and below the movable assembly.

14. The unloading and collecting device for slice of claim 9, wherein the box is disposed on a side of the movable member away from the silicon rod and below the movable assembly.

15. The unloading and collecting device for slice of claim 10, wherein the box has an opening upward, and an elastic pad is arranged at least on a bottom of the box.

16. A cutting machine, comprising the unloading and collecting device for slice of claim 1.

17. A cutting machine, comprising the unloading and collecting device for slice of claim 2.

18. A cutting machine, comprising the unloading and collecting device for slice of claim 3.

19. A cutting machine, comprising the unloading and collecting device for slice of claim 4.

20. A cutting machine, comprising the unloading and collecting device for slice of claim 5.
